(19) United States
(12) Patent Application Publication
(10) Pub. No.: US 2008/0140437 A1
(43) Pub. Date: Jun. 12, 2008

(54) METHOD FOR DISPENSING AND SELLING FROZEN CONFECTION PRODUCTS

(75) Inventors: Flavio Russo, Parma (IT); Bruno Sadi Henri Delande, Marseille en Beauvaisis (FR)

Correspondence Address: BELL, BOYD & LLOYD LLP, P.O. Box 1135, CHICAGO, IL, 60690, US

(73) Assignee: NESTEC S.A., Vevey (CH)

(21) Appl. No.: 11/943,842

(22) Filed: Nov. 21, 2007

Related U.S. Application Data
(60) Provisional application No. 60/869,228, filed on Dec. 8, 2006.
(60) Provisional application No. 60/894,539, filed on Mar. 13, 2007.

(51) Int. Cl. G06Q 30/00

(52) U.S. Cl. 705/1

(57) ABSTRACT

Methods for selling or dispensing frozen confections to a consumer are provided, the method can comprise the steps of producing a frozen confection in a consumer's view using a batch freezer, selling the frozen confection to the consumer, and cleaning the batch freezer while it is in the consumer's view.

### CROSS-REFERENCE TO RELATED APPLICATIONS

The present application contains subject matter related to U.S. Patent Application No. 60/869,228, METHOD FOR DISPENSING AND SELLING FROZEN CONFECTION PRODUCTS, filed on Dec. 8, 2006; and U.S. Patent Application No. 60/894,539, METHOD FOR DISPENSING AND SELLING FROZEN CONFECTION PRODUCTS, filed on Mar. 13, 2007, the entire contents of which are incorporated herein by reference.

### BACKGROUND

The present disclosure generally relates to methods for dispensing and selling frozen confections such as, for example, ice cream. The disclosure also relates to methods for generating revenue from frozen confections at a retail site as well as methods for operating such sites.

It is, of course, known to dispense and sell frozen confections to consumers. Such products can be sold, for example, on cones or in containers. These confection products are typically dispensed to a consumer from a package or other housing that stores the frozen confection, e.g., ice cream, until it is provided to the consumer. It is also known to use enclosed machines for producing and dispensing soft frozen confections to the consumer, e.g., a soft serve ice cream dispenser.

One way to produce frozen confections, such as ice cream, is to use a batch freezer. Batch freezers are known from the prior art. A general introduction can be found e.g. in the standard literature such as e.g. “Ice Cream”, fifth edition, Arbuckle et al.

Usually batch freezers are used for small-scale production of, e.g., ice cream. These freezers are usually located on small-scale production sites which are not visible to the consumer.

While ice cream production with such a batch freezer does not have an unaesthetic aspects, it has to be noted that after a certain period of use, or after changing the ice cream flavor to be produced, the batch freezer should be thoroughly cleaned and eventually sterilized. This process includes the drainage of waste water which is not aesthetically appealing to a potential consumer at a vending site. Thus the cleaning process for known batch freezers constitutes an obstacle against using same in sight of a potential consumer.

### SUMMARY

The present disclosure provides various methods for operating retail facilities for dispensing and selling frozen confections. Additionally, the present disclosure provides various methods for generating revenue from the sale of frozen confections.

In an embodiment, the present disclosure provides a method for selling a frozen confection to a consumer comprising the steps of: producing a frozen confection in a consumer's view using a batch freezer; selling the frozen confection to the consumer; and cleaning the batch freezer while it is in the consumer's view. These steps can occur in any order.

In an embodiment, the frozen confection is ice cream.

In an embodiment, the frozen confection is placed on a cone or in a cup or other container.

In a further embodiment, the present disclosure provides a method for designing a retail operation for selling a frozen confection comprising the steps of: using a batch freezer to produce at least some of the frozen confection; and positioning the batch freezer so that the process of making the frozen confection using the batch freezer and cleaning the batch freezer will be viewable to the consumers.

In another embodiment of the present disclosure, a method of generating revenue in a retail outlet from the sales of a frozen confection is provided comprising the steps of: producing a frozen confection ordered by a consumer so that the process is viewable by the consumer using, at least in part, a batch freezer; selling the frozen confection to the consumer; and cleaning the batch freezer during operations of the retail outlet without moving or covering the batch freezer.

Still further, in an embodiment, the present disclosure provides a method of generating revenue comprising the steps of selling to a retail facility ingredients to make a frozen confection, the retail facility operating such that the process of making the frozen confection is viewable by the consumer using a batch freezer that is cleaned while still viewable to the consumer.

As noted above, a batch freezer for frozen confections can be used. The batch freezer can comprise a freezing cylinder which usually is oriented in a horizontal position. A dasher can be arranged inside the freezing cylinder and is designed to propel the product to a water discharge port of the freezing cylinder. A refrigeration unit is arranged for cooling the cylinder during the freezing process for the food product. The discharge port of the freezing cylinder can be selectively connected to a cleaning pipe leading from the discharge port into the casing of the batch freezer. During a cleaning (rinsing) process of the freezing cylinder, waste water can be drained from the freezing cylinder through the discharge port and then fed back into the casing of the batch freezer through the cleaning pipe. If the cleaning pipe is made of a non-transparent material such as for example stainless steel, the waste water will not be visible such that the cleaning process using a cleaning pipe according to the present disclosure can even be carried out when the batch freezer is placed at a vending site and in plain view of potential consumers.

The cleaning pipe can have a first external section which externally connects the discharge port with a second, internal section of the cleaning pipe, wherein the second, internal section is arranged inside a casing of the batch freezer. The internal section can comprise a siphon pipe in order to suppress orders (bad smell or odour).

In an embodiment, the first external section of the cleaning pipe can have one open end which can be selectively tightly connected to the discharge port and the second, internal section of the cleaning pipe is preferably fixedly mounted inside the casing of the batch freezer.

The first, external section of the cleaning pipe can be designed to be rotatable around an axis through the connection portion of the first, external section to the second, internal section of the cleaning pipe. The first, external section of the cleaning pipe can be mounted in a rotatable manner, such that it can be rotated between an essentially horizontal stand-by orientation and an orientation in which can be connected to the discharge port of the batch freezer. The first, external section of the cleaning pipe can be bent, such that it can be designed to serve as a support when in the horizontal position. In this regard an additional grill, plate or other support structure can be fixed to the bend first section of the cleaning pipe.

A water inlet can be provided on top of the freezing cylinder in order to feed preferably hot water to the freezing cylinder when carrying out a rinsing and cleaning of the freezing cylinder. Preferably the cleaning pipe exits the body (casing) of the batch freezer at it's rear side such that the acid and the corresponding discharge of waste water is not visible from the front of the batch freezer.

Systems for producing frozen food products, such as for example ice cream at a vending site are also provided. The systems can comprise a batch freezer as well as a package of a batch of a ready-to-freeze liquid ingredient mix for the frozen food product. The batch freezer can be provided with means for identifying a supplied ingredient mixed package, e.g. in order to control a subsequent frozen food production process depending on the information on the identity of the ingredient mix.

Methods for operating a batch freezer are also provided. In an embodiment, a package of a batch of a ready-to-freeze liquid ingredient mix for a frozen food product, such for example ice cream, sorbet etc. is provided. The liquid ingredient mix is then fill from the package into a freezing cylinder to batch freezer. The liquid mix is frozen and then discharged from a discharge port of the freezing cylinder. Then the discharge port is connected to a cleaning pipe of the batch freezer, the cleaning pipe connecting the discharge port externally to an internal section of the cleaning pipe. Finally the freezing cylinder can be cleaned by rinsing it with hot water, which is then discharged to the cleaning pipe.

The method can comprise the step of operating a dasher of the batch freezer once the freezing cylinder is at least partially filled with water in order to thoroughly clean dasher and/or the freezing cylinder. The freezing cylinder can be selectively connected to a hot water inlet. The batch freezer can identify a supplied ingredient mix package in order to control a subsequent freezing operation depending on the identified information.

It is an advantage of the present disclosure to provide methods of selling and dispensing frozen confections in a retail facility where the production of the frozen confection is viewable to the consumer.

Another advantage of the present disclosure is to provide new methods for operating a retail outlet that generates revenue from frozen confections.

Still further, an advantage of the present disclosure is to provide methods for increasing revenue and/or distinguishing a retail outlet that generates revenue from frozen confections from retail outlets that operated heretofore.

Moreover, an advantage of the present disclosure is to provide new arrangements and layouts for a retail operation that dispenses frozen confections.

Additional features and advantages are described herein, and will be apparent from, the following Detailed Description and the figures.

### BRIEF DESCRIPTION OF THE FIGURES

FIG. 1 illustrates a side view, a front view and a top view of an embodiment of a batch freezer of the present disclosure.

FIG. 2 illustrates the freezer of FIG. 1 in a status in which it can be cleaned.

FIG. 3 illustrates an internal view of parts of the freezer of FIG. 1.

FIG. 4 illustrates an embodiment of a package which can be used together with a freezer of FIGS. 1-3.

### DETAILED DESCRIPTION

The present disclosure relates generally to methods for generating revenue and selling and dispensing frozen confection products. A variety of such frozen confection products are possible including ice cream, frozen yogurt, and sorbet.

Pursuant to the present disclosure, generally, a method is provided for operating a retail facility, for example, an ice cream store. Pursuant to the method, the process of making the frozen product is viewable to the consumer. By providing a method of making the product in the vision of the consumer, it is believed that this will distinguish the retail facility from typical retail facilities that sell frozen confections thereby increasing sales and/or consumer traffic.

As used herein, “viewable to the consumer” means that a consumer standing in an area typically occupied by a consumer is able to view the process. This would include a location such as in front of a cash register or other area in which a financial transaction takes place, an area where the consumer is ordering the product, or an area where the consumer is waiting either to order the product, receive the product, or pay for the product. What is not encompassed by the term “viewable to the consumer” is an area that is typically only accessible or occupied by an employee of the retail facility or a separate room that is typically only accessible to the employee.

As used herein, the terms “retail facility,” “retail outlet,” or “retail operation” refer to a store, facility, outlet, cafeteria, restaurant, kiosk, or other location where product is sold, vended, or dispensed to a consumer, typically in exchange for a payment.

Pursuant to an embodiment of the present disclosure, the frozen confection can be made, at least partially, when it is ordered by the consumer. This could provide a different approach to providing frozen confections to a consumer. Typically, frozen confections are pre-made, at least in substantial part, out of a consumer's view prior to being ordered by the consumer and are then housed in containers from which they are dispensed when ordered.

Although the product, pursuant to the present disclosure, can be made when ordered, however, it should be noted that typically at least a portion of the frozen confection, if not the entire product, will be made before the consumer orders the product. In this regard, using a batch freezer, one will make enough product for multiple servings. Thus, depending when a batch is made, it may or may not be made when ordered by the customer. Moreover, it is envisioned that, in an embodiment, certain ingredients, flavors, could be added to an already made batch of frozen confections when ordered by the customer.

Pursuant to the present invention, the frozen confection product is prepared, at least in substantial part, in the view of the consumer. This means that the consumer views or sees the production of the frozen confection product. This is opposed to the situation where the product is made at a different location, housed in a container, and then scooped or otherwise removed from the container when the product is ordered by the consumer. In addition, this method also differs from the situation where, for example, for soft serve ice cream, the product is dispensed from a machine. Such a process of making the confectionery product is still not in the consumer's view because it takes place inside of an enclosed machine.

Thus, in one embodiment of the present disclosure, a consumer will enter the retail facility and order a frozen confection, for example, ice cream. The ice cream product will then be made in the consumer's view although not necessarily depending on timing and product that has already been made. Either before, during, or after the process of making the ice cream, the consumer will pay for the ice cream and then will receive same.

One of the aspects of the present disclosure, in an embodiment, is that a batch freezer, in which the frozen confection product can be made, can be cleaned in view of the consumer. This is in contrast to previous batch freezers wherein the cleaning process was not aesthetically pleasing and therefore had to take place outside of the consumer's view. Therefore, by providing a batch freezer cleaning process that is not aesthetically unpleasing, one is able to use the batch freezer to prepare the confectionery product in view of the consumer. Moreover, one is able to clean the batch freezer during operations of the retail facility, i.e., when the facility is open for business and consumers.

By way of example and not limitation, examples of the batch freezer will now be set forth. It should be noted that other devices can be used with the batch freezer or instead of the batch freezer pursuant to the present disclosure.

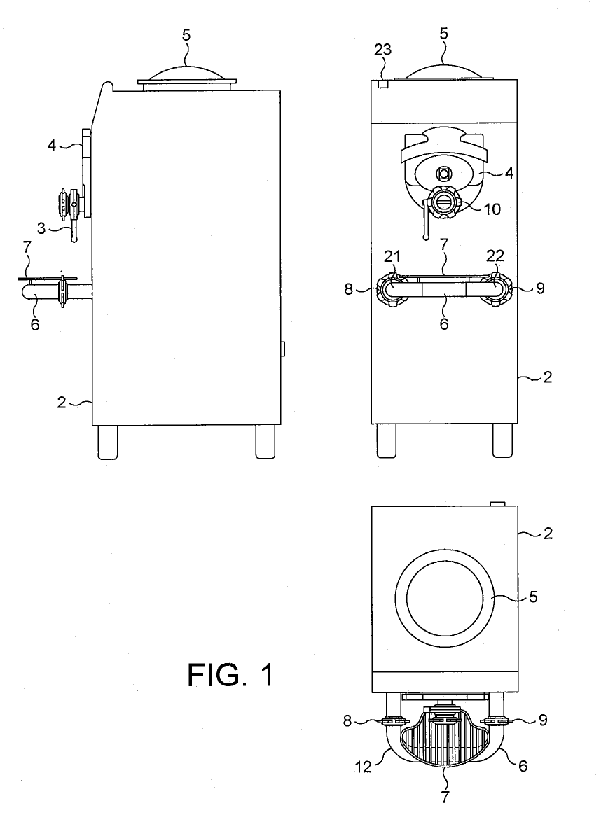

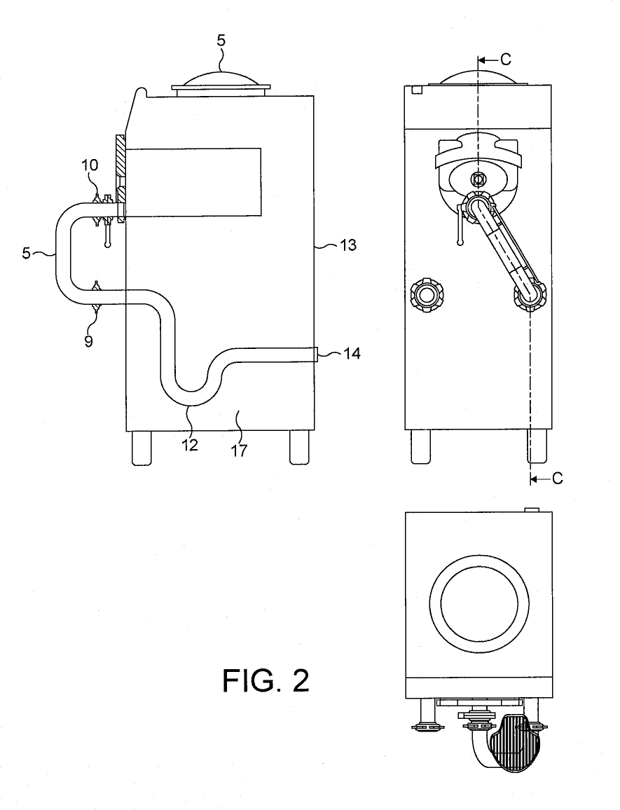

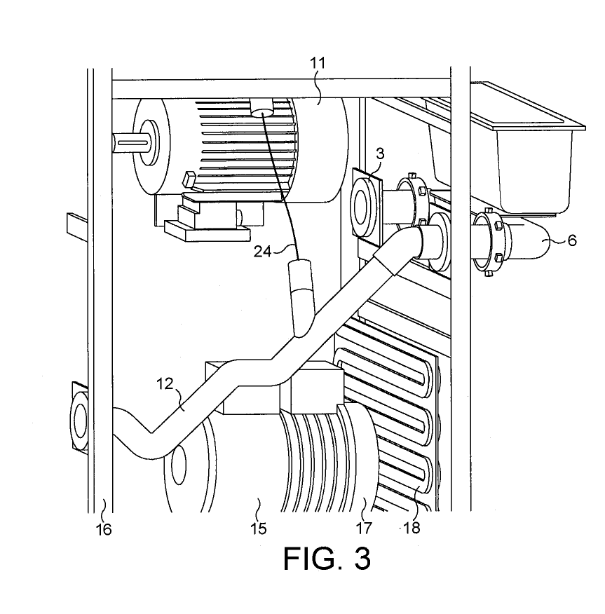

FIG. 1 illustrates a batch freezer 1 for production of frozen confectionery products, such as, for example, ice cream. The ingredients can be loaded, preferably in a liquid state, into a freezing cylinder 11 (see FIGS. 2 and 3) from the top of the batch freezer 1 through a top opening 5 which communicates with the freezing cylinder 11.

At the front side of the casing 2 of the batch freezer 1 there is arranged a door 4 for access to the freezing cylinder 11, the door being provided with a valve 3, such as for example a butterfly valve for selectively closing of the interior of the freezing cylinder 11. A dasher, which is not shown in the drawings, can be arranged inside the freezing cylinder 11 to propel the frozen product towards the door 4 when in operation.

On the front side of the batch freezer 1 there is also arranged a section 6 of a cleaning pipe which, in the position of FIG. 1, is arranged in a horizontal position such that it can act as a horizontal support stand. In this regard a grill or plate 7 can be attached (e.g. by welding) to the external section 6 of the cleaning pipe. The section 6 of the cleaning pipe is fixed to the casing 2 via two nods 8, 9. Preferably the external section 6 is made from a non-transparent material such as e.g. stainless steel.

As will be explained later on with reference to FIG. 2, the end 21 of the cleaning pipe is an open end attached to the nod 8, while the other end 22 of the bent, external section 6 of the cleaning pipe communicates with a further, internal section of the cleaning pipe. The external section 6 is mounted in a rotatable manner vis-á-vis the casing of the batch freezer 1 and the internal section 17 of the cleaning pipe.

In the state of the batch freezer illustrated in FIG. 2 ice cream can be produced inside the freezing cylinder 11, wherein the freezing cylinder is cooled by a refrigeration unit. As is known, a dasher can propel the product produced in the freezing cylinder 11 towards to the discharge port 3. Upon opening the valve of the discharge port 3 the produced frozen confection product can be obtained from the batch freezer.

After a defined period of time of use of the batch freezer 1, a regular interval, or every time when changing the flavor of the product to be produced in the batch freezer 1, all parts of the batch freezer which have been in contact with the frozen product have to be cleaned. In order to carry out the cleaning process, the batch freezer 1 is transferred from the operation state as shown in FIG. 1 to the cleaning state as illustrated in FIG. 2.

Essentially the bend portion 6 of the cleaning pipe is rotated (in a clockwise direction in the illustrated example) such that the open end 21 of the bend section 6 is tightly connected to the discharge port 3 via a nod nipple 10. As can be seen from FIG. 2, the second end 22 of the bend, external section 6 of the cleaning pipe remains in communication with the internal section 17 of the cleaning pipe. The second, internal section 17 can provide a siphon section 12. The internal section 17 is also preferably made from stainless steel.

FIG. 3 illustrates parts of the batch freezer 1 of FIGS. 1 and 2, wherein among other parts, the casing is removed for better illustrations. In FIG. 3 the refrigeration unit 15 and a heat exchanger unit 18 are illustrated. The external section 6 of the cleaning pipe is connected to the discharge port 3 and communicates with the internal section 17 of the cleaning pipe.

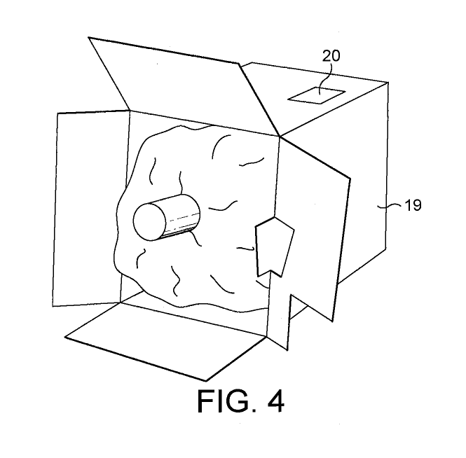

As illustrated in FIG. 3, a direct connection 24 from this cleaning pipe 17 to the freezing cylinder 11 can be provided, shunting the external section 6 and being designed for a cleaning of the dash pinion. The batch freezer as illustrated in FIGS. 1-3 is particularly suited to be used in combination with a package 19 (see FIG. 4) containing a liquid ready-to-freeze ingredient mix for the frozen confectionery product to be produced.

Preferably the batch freezer 1 is provided with detecting means (23 in FIG. 1) which are in functional connection with control means for the operation of the batch freezer 1. Correspondingly the package 19 (see FIG. 4) can be provided with identification-carrying means 20 (such as for example a RFID tag etc.) such that the sensing means 23 of the batch freezer 1 can read identification information from the package 19 in a wireless or a non-wireless manner. Thus the frozen confection product production operation of the batch freezer 1 can be controlled depending on the read identification information from the package 19, e.g., operation parameters (time, temperature, operation of the dasher etc.) can be set depending on the read identification information. Additionally alternatively the operation of the batch freezer 1 can only be enabled in case the correct associate information can read from the package 19 in order to prevent the use of the batch freezer 1 with ingredients which are not adapted for the batch freezer 1.

A batch freezer 1 as illustrated in FIGS. 1-3 can even be installed at a variety of locations. By way of example, the batch freezer can be designed to produce 1 to 3 ice cream trace (of 5 liters each) during the day. The batch freezer 1 can be cleaned, preferably by rinsing it with hot water, at the each different each cream flavor production. In case the batch freezer 1 is installed in a vending side, the cleaning has obviously to be done in front of a potential consumer.

For the cleaning (rinsing) operation the top loading mechanism 5 for the ice cream ingredients can be used for as a hot water inlet.

The freezer cylinder 11 can be connected to the cleaning pipe in very short time and the waste water can be collected to the drain without disadvantageous aesthetic effects. The inner cleaning type section 17 is fixedly installed inside the freezer body (casing) 2. The cleaning pipe is preferably made from stainless steel. The external cleaning pipe section 6 with bents and unions extremities is arranged at the front of the batch freezer 1. One union 22 is connected to the internal pipe section through a nod nipple 9, while the other one (open end) is connected to a fix union (nod nipple 8 in FIG. 1). The distance between the nod nipple 8 and the nod nipple 9 corresponds to the distance of the nod nipple 9 to the nod nipple 10 of the discharge port 3.

In an embodiment, the cleaning process can be performed as follows:

The ice cream nozzle is completely detached (unscrewed) from the door 4. The nozzle can then be cleaned separately in a cleaning tank. The nod nipple 8 is completely unscrewed from a fix support on the casing 2 of the batch freezer 1. The nod nipple 9 is partially unscrewed (lucent) and then the external pipe section 6 can be rotated e.g. by 60° in the clockwise direction. The nod nipple 8 can then be completely (tightly) screwed on the nozzle screw 10. The valve 3 of the discharge port is closed.

Hot water can be supplied to the freezing cylinder 11 through the top loading mechanism 5. Optionally then the dasher rotation can be started. When the freezing cylinder 11 has been filled with water, the valve 3 can be opened in order to discharge waste water through the cleaning pipe. Then the hot water inlet can be closed and the cleaning pipe can be unconnected. The cylinder door 4 can be opened and the dasher can be cleaned and the cylinder can be tried. The freezer 1 is then ready to start a new ice cream production process.

As illustrated in FIGS. 1 and 2, a stainless steel support 7 can be welded to the external pipe section 6. During ice cream production, this support can be used as a container support.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for selling a frozen confection to a consumer comprising the steps of:
producing a frozen confection so that it is viewable to a consumer using a batch freezer;
selling the frozen confection to the consumer; and
cleaning the batch freezer while the batch freezer is viewable to the consumer.

2. The method of claim 1 wherein the frozen confection is selected from the group consisting of ice cream, frozen yogurt, and sorbet.

3. The method of claim 1 wherein the step of cleaning occurs before the step of selling or producing.

4. The method of claim 1 wherein the batch freezer is cleaned at a regular interval.

5. The method of claim 1 wherein the batch freezer is cleaned when the flavor of frozen confection is changed.

6. A method for designing a retail operation for selling a frozen confection comprising the steps of:
using a batch freezer to produce at least some of the frozen confection; and
positioning the batch freezer so that the process of making the frozen confection using the batch freezer and at least a portion of the process of cleaning the batch freezer is viewable to the consumer.

7. The method of claim 6 wherein the frozen confection is selected from the group consisting of ice cream, frozen yogurt, and sorbet.

8. The method of claim 6 wherein the batch freezer is cleaned at a regular interval.

9. The method of claim 6 wherein the batch freezer is cleaned when the flavor of frozen confection is changed.

10. A method of generating revenue in a retail outlet from the sales of a frozen confection comprising the steps of:
producing a frozen confection ordered by a consumer using a process that is viewable by a consumer using, at least in part, a batch freezer;
selling the frozen confection to the consumer; and
cleaning the batch freezer during operations of the retail outlet without moving or covering the batch freezer either before or after the producing step.

11. The method of claim 10 wherein at least a portion of the frozen confection is produced when ordered by the consumer.

12. The method of claim 10 wherein the frozen confection is selected from the group consisting of ice cream, frozen yogurt, and sorbet.

13. The method of claim 10 wherein the batch freezer is cleaned at a regular interval.

14. The method of claim 10 wherein the batch freezer is cleaned when the flavor of frozen confection is changed.

15. The method of claim 10 wherein the batch freezer comprises a freezing cylinder, a discharge port of the cylinder, and a refrigeration unit arranged for cooling the cylinder, the discharge port is connected to a cleaning pipe leading from the discharge port into the casing of the batch freezer.

16. The method of claim 10 wherein a system is used comprising the batch freezer and a package of a batch of a ready-to-freeze liquid ingredient mix for the frozen food product.

17. The method of claim 10 comprising the steps of:
providing a package of a batch of a ready-to-freeze liquid ingredient mix for a frozen food product; and
filling the liquid ingredient mix from the package into the batch freezer.

18. The method of claim 17 comprising the steps of:
freezing the mix and discharging the frozen product from a discharge port of the freezing cylinder;
connecting the discharge port to a cleaning pipe of the batch freezer; and
cleaning the freezing cylinder by rinsing it with hot water which is then drained through the cleaning pipe.

19. The method according to claim 17 wherein the batch freezer identifies a supplied ingredient mix package.

20. A method of generating revenue comprising the steps of:
selling to a retail facility ingredients to make a frozen confection, the retail facility operating such that the process of making the frozen confection is viewable by the consumer using a batch freezer that is cleaned while the batch freezer is viewable by the consumer.
